(19) United States
(12) Patent Application Publication
(10) Pub. No.: US 2017/0215450 A1
(43) Pub. Date: Aug. 3, 2017

(54) METHOD FOR MAKING A PARTIALLY COOKED CHEESE PRODUCT AND USES THEREOF

(71) Applicant: LOTITO FOODS HOLDING, LLC, Edison, NJ (US)

(72) Inventor: Christopher L. LOTITO, Edison, NJ (US)

(21) Appl. No.: 15/411,216

(22) Filed: Jan. 20, 2017

Related U.S. Application Data
(60) Provisional application No. 62/290,685, filed on Feb. 3, 2016.
(60) Provisional application No. 62/291,145, filed on Feb. 4, 2016.
(60) Provisional application No. 62/306,917, filed on Mar. 11, 2016.

(51) Int. Cl. A23C 19/068; A21D 13/20; A23C 19/09

(52) U.S. Cl. CPC A23C 19/068; A23C 19/0925; A21D 13/20

(57) ABSTRACT

The invention relates to a method for preparing a partially cooked cheese product, as well as the partially cooked cheese product itself. The method appears applies specific times and temperatures to produce a pliable, carbohydrate free cheese product, which is free of carbohydrates. The product can be used, for example, as a carbohydrate free all cheese bread substitute in “sandwich wraps” or other applications.

### RELATED APPLICATIONS

This application claims priority from U.S. Provisional Application No. 62/290,685 filed Feb. 3, 2016; U.S. Provisional Application No. 62/291,145 filed Feb. 4, 2016; and U.S. Provisional Application No. 62/306,917 filed Mar. 11, 2016, all of which are incorporated by reference in their entities.

### FIELD OF THE INVENTION

This invention relates to a method for manufacturing a partially cooked cheese product. A further feature of the invention are the partially cooked cheese products themselves, which can be used per se as, e.g., wraps, or can be further processed to form cheese crisps.

### BACKGROUND

“Cheese crisps,” “parmesan crisps,” or “frico” are a standard product used, e.g., as snacks, additives to salads or other dishes, etc. “Frico” derive from Northern Italian cooking, and are made from montasio cheese. As this cheese can be difficult to find, other varieties, especially parmesan, have been used instead, and indeed, most consumers are familiar with “parmesan crisps,” rather than frico.

The product will be referred to as a cheese crisp hereafter.

These cheese crisps can be made in various sizes. Smaller ones, e.g., less than 3 inches in diameter, exhibit greater stability, but are not as desirable for restaurant service as larger ones are. While any restaurant can make these from scratch, it will be understood that issues of space, staff, etc., often preclude this. If the product is made before service, its fragility becomes a problem, as do issues of storage. Hence, many restaurants purchase pre-made cheese crisps, but as noted supra, larger products are not generally available because of fragility.

It has now been found that a partially cooked cheese product can be prepared which is stable, i.e., avoids the fragility problem discussed supra, can be shipped to customers where the product can be finished, and is adaptable to a variety of different cheeses and mixtures of cheeses. The invention described herein permits an end user, such as a restaurant, to reduce the amount of time necessary to prepare the crisps described herein, since they are already partially cooked. Further, the process of the invention yields a product which is flexible, rather than crispy, and avoids problems caused by the fragility of the end product, e.g., crumbling. As a result, the partially cooked cheese product of the invention can also be used as a gluten-free, “all cheese” wrap product, i.e., a product which replaces a tortilla, pita, or other flat form of bread and surrounds an edible filing as, e.g., a sandwich wrap or other food product.

### DETAILED DESCRIPTION

In a preferred embodiment, one or a mixture of cheeses are first grated. Many types of cheeses require no treatment to be made “gratable,” (e.g., parmesan, pecorino, asiago, manchego, montasio, Jarlsberg, dry Jack and aged provolone) while others might benefit from pretreatment, such as short-term freezing. Exemplary of such are fontina, gouda, cheddar, comte, caciocavallo and young provolone.

The artisan of ordinary skill will recognize that some cheese varieties are simply not suitable for grating, such as ricotta, mascarpone and other cheeses which are eaten fresh, with a high concentration of liquid, rather than being aged.

Optionally, one can add flavoring materials to the grated cheese, or stabilizers, such as flour. Flavoring agents including but are not limited to, black pepper, fresh or dried herbs, dried vegetables such as tomatoes or peppers, chopped olives, and so forth. In the carbohydrate free embodiment discussed infra, ingredients such as flour are not included.

The mixture is then placed on a baking sheet or other oven-safe device, preferably coated with, e.g., Silpat®, parchment, or other material to prevent adherence to the baking sheet. For each crisp product, sufficient mixture is deposited to form a finished product about 3-10 inches, preferably, 4-8 and most preferably, 5-7 inches in diameter. The mixture does not spread much in cooking, so the amounts of mixture are not critical, as long as it is spread to form a round of desired size. “Diameter” is used to refer to the product when it is prepared as a round; however, the skilled artisan will recognize that any shape may be prepared in accordance with the invention, and “diameter” should be take to refer to the longest dimension of the product, when the product shape is not circular, such as a round.

Once the baking sheet, e.g., is filled with cheese shapes, it is subjected to pressure, placed in a preheated oven, set at a temperature of from about 300 to about 425° F., preferably 350° F. The mixture melts, loses any whey liquid along with a small portion of moisture contained therein, and forms a somewhat pliable product. This product is removed from the oven after a very short time, i.e., from about 1 to about 6, and preferably about 3 minutes, and allowed to cool to ambient temperature. On an industrial scale this is accomplished by having the baking sheet move down a conveyer belt, but on a small scale, it is a simple matter to allow the product to cool for, 3-10 minutes.

When cooled to ambient temperature, the cheese rounds can then be packaged, e.g., by separating them on smaller sheets of parchment paper, stacked one upon the other, and then sealed, e.g., in a vacuum packed, sealable plastic container, such as a bag. The products are “made to order,” i.e., they are not presented as a storable commodity such as potato chips or crackers. The products are perishable and should be refrigerated prior to use.

Instructions are provided, either in the form of an insert, or printed on the container, for how to finish the product and make it a “crisp.” Essentially, the user can bake the product at about 375° F. for about 15 minutes, use a microwave for 45-90 seconds, or pan fry them on a non-stick surface for about 1-2 minutes.

For a very short window of time, the user can shape the crisp via, e.g., molding it over a cup or other receptacle, rolling it into a tube or cone, and so forth. Larger shapes may be molded into bowls or other receptacles to hold salad, pasta, etc. Other means for shaping the final product will be known to the skilled artisan. Alternatively, as noted supra, the flexible partially cooked products can be used as “wraps” in place of any other product which would be used to enclose other food products, such as tortillas, fresh pasta (e.g., for stuffed pasta), pita bread, crepes and so forth. As the cheeses used in the invention are known to be carbohydrate free (as defined by the USDA), the flexible cheese product can serve as a high protein, carbohydrate free alternative.

The terms and expression which have been employed are used as terms of description and not of limitation, and there is no intention in the use of such terms and expression of excluding any equivalents of the features shown and described or portions thereof, it being recognized that various modifications are possible within the scope of the invention.

1. A method for preparing a partially cooked cheese product, comprising:
(i.) grating one or more cheeses to form a grated cheese product;
(ii.) placing a quantity of grated cheese product on a non-adherent baking surface subjected to pressure to form a disc of from about 3 to about 10 inches at its greatest linear dimension;
(iii.) baking said cheese product at a temperature of from about 300° F. to about 425° F., for a period of from about 1 to about 6 minutes;
(iv.) removing the baked cheese product from said oven, and
(v.) permitting said cheese product to cool to ambient temperature, to form a partially cooked cheese product.

2. The method of claim 1, further comprising a flavoring agent or stabilizing agent to said grated cheese product.

3. The method of claim 1, comprising forming a shape of from about 4 to about 8 inches.

4. The method of claim 1, comprising forming a shape of from about 5 to 7 inches.

5. The method of claim 1, comprising baking said cheese product at a temperature of about 350° F. for about 3 minutes.

6. The method of claim 5, further comprising packaging said cheese product.

7. The method of claim 6, further comprising including instructions for finishing said partially cooked cheese product.

8. The method of claim 1, further comprising completely cooking said partially cooked cheese product.

9. The method of claim 8, comprising baking said partially cooked cheese product at a temperature of about 375° F. for about 15 minutes.

10. The method of claim 8, further comprising microwaving said partially cooked cheese product.

11. The method of claim 8, further comprising frying said partially cooked cheese product on a non-stick surface for about 2-3 minutes.

12. A partially cooked cheese product prepared via the method of claim 1.

13. A food product comprising an edible filling encircled by the partially cooked cheese product of claim 12.
